(19) United States
(12) Patent Application Publication
(10) Pub. No.: US 2026/0008620 A1
(43) Pub. Date: Jan. 8, 2026

(54) Automated Storage and Retrieval System

(71) Applicant: ABB Schweiz AG, Baden (CH)

(72) Inventors: Tianxing Ma, Meerbusch (DE); Julian Broecheler, Münster (DE)

(73) Assignee: ABB Schweiz AG, Baden (CH)

(21) Appl. No.: 19/328,346

(22) Filed: Sep. 15, 2025

Related U.S. Application Data
(63) Continuation of application No. PCT/EP2023/056612, filed on Mar. 15, 2023.

(51) Int. Cl. B65G 1/137; G06Q 10/087

(52) U.S. Cl. CPC B65G 1/1378; G06Q 10/08741

(57) ABSTRACT

An automated storage and retrieval system includes a storage unit configured to accommodate a first plurality of cases; a supply unit configured for providing at least one of the first and/or a second plurality of cases; a storage and retrieval machine configured to access the plurality of cases of the storage unit and to provide at least one of the plurality of the cases to the supply unit; wherein the storage and retrieval system enables access to the second plurality of cases stored by a first mobile rack using the storage and retrieval machine.

### CROSS-REFERENCE TO RELATED APPLICATIONS

The instant application claims priority to International Patent Application No. PCT/EP2023/056612, filed Mar. 15, 2023, which is incorporated herein in its entirety by reference.

### FIELD OF THE DISCLOSURE

The present disclosure generally relates to automated storage and retrieval systems and methods.

### BACKGROUND OF THE INVENTION

Using goods to person systems in modern logistics industry is very common and has experienced exponential growth for a decade. Since emergence of this trend, more players have entered the market offering their proprietary goods-to-person solution.

### BRIEF SUMMARY OF THE INVENTION

Traditional goods to person solutions can have problems resulting in inefficiencies and/or higher system cost. For example, a picking station can have a limited order pool, i.e. a put wall, wherein dimensions can be restricted by a design limitation originated by a handling spans around a human operator for reaching all possible placing locations without being required to walk. This can result in limited hitting rates for each transported mobile rack, wherein the hitting rate describes a chance that several order lines to be picked for orders on the put wall can be accessed from the same rack, i.e. chances that all items to be picked are located in one rack. Accordingly, a lower hitting rate can result in a higher quantity of transportation by means of mobile racks, which can result in a higher amount of autonomous mobile robots (AMR) needed in the system, increasing the overall system cost.

In addition, conventional goods-to-person systems can only fulfill tasks when picking stations are staffed, i.e. moving racks together with operators for picking items. That is, because an operator is always needed at a picking station to manually pick the items and for operating a mobile rack. A system utilization is thereby limited by operation times and/or operator shifts. Other than that, conventional goods-to-person systems are limited in respect to the possibility of optimizing the system, i.e. a conventional goods-to-person system always needs an operator to relocate goods and/or to optimize inventory.

With a traditional mobile rack goods to person solution, an operator needs to pick directly from the mobile rack, sometimes with the help of a ladder to reach higher racks. Depending on the scenario and order profile normally operators can pick between one to three order lines from each rack, wherein one order line refers to a single item type. This requires a queue of racks in front of an order picking station to ensure the operator can always pick the items without idle time. As a consequence, the goods-to-person system needs to feed the mobile racks frequently, which requires a higher quantity of mobile robots to move these racks. Furthermore, frequent exchange of mobile racks reduces the overall system utilization and picking efficiency.

The present disclosure generally describes an automated storage and retrieval system including a storage unit, a supply unit, and a storage and retrieval machine. The storage unit can be configured to accommodate a first plurality of cases. The supply unit can be configured for providing at least one of the first plurality of cases and/or at least one of a second plurality of cases. The storage and retrieval machine can be configured to access the plurality of cases of the storage unit and to provide at least one of the respective plurality of the cases to the supply unit. Additionally, the storage and retrieval system can be configured for enabling access to the second plurality of cases, which can be stored by means of a first mobile rack by means of the storage and retrieval machine.

The term “case” is a generic term including different systems to store items using a container and/or a carton and/or a storage bin and/or a tote etc. The cases being uniform and/or non-uniform.

### BRIEF DESCRIPTION OF THE SEVERAL VIEWS OF THE DRAWING(S)

FIG. 1 is a diagram of a layout of an automated storage and retrieval system in accordance with the disclosure.

FIG. 2 is a diagram of a layout of an automated storage and retrieval system in accordance with the disclosure.

FIG. 3 is a flowchart for a control system in accordance with the disclosure.

### DETAILED DESCRIPTION OF THE INVENTION

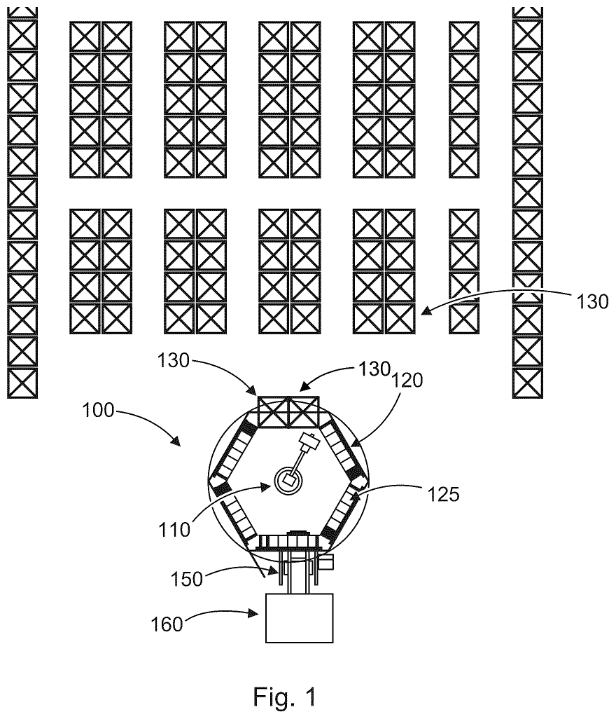

FIG. 1 schematically sketches an automated storage and retrieval system 100 including a storage unit 120, a storage and retrieval machine 110 and a plurality of mobile racks 130. The storage unit 120 is configured to accommodate a first plurality of cases at a periphery border in respect to a center of the storage unit 120, wherein the first plurality of cases can be stored in a plurality of shelves 125 of the storage unit 120. A first mobile rack 130 and a second mobile rack 130 can be placed at the peripheral border of the storage unit 120, wherein the first mobile rack 130 is configured to store a second plurality of cases and the second mobile rack 130 is configured to store a third plurality of cases.

The storage and retrieval machine 110 can be configured to operate in a center of the storage unit 120 and can be configured to have access to the first plurality of cases, which are accommodated by the storage unit 120, and also to have access to the second plurality of cases, which are stored in the first mobile rack 130, and also to have access to the third plurality of cases, which are stored in the second mobile rack 130, which are placed at the periphery border of the storage unit 120, by means of a serial robot arm 110.

The storage and retrieval system 100 includes a supply unit 150 for providing at least one of the first plurality and/or second plurality and/or third plurality of cases from the storing unit 120 and/or one of the respective mobile racks 130 to an outside of the storage and retrieval system 100 by means of the supply unit 150.

The supply unit 150 can include a conveyor 150 to provide the respective case to a picking station 160 to give an operator access to the case. The conveyor 150 can be a U-turn type for retrieving a provided case to the automated storage and retrieval system 100.

A plurality of mobile racks 130, including the first mobile rack 130 and the second mobile rack 130, can be stored outside of the storage and retrieval system 100. An respective mobile rack 130 of the plurality of mobile racks 130 can be configured to be moved by an autonomous mobile robot of a plurality of autonomous mobile robots to the periphery border of the storage unit 120 to give the storage and retrieval machine 110 access to at least one case of the plurality of second and/or third plurality of cases stored within the first and/or second mobile rack 130.

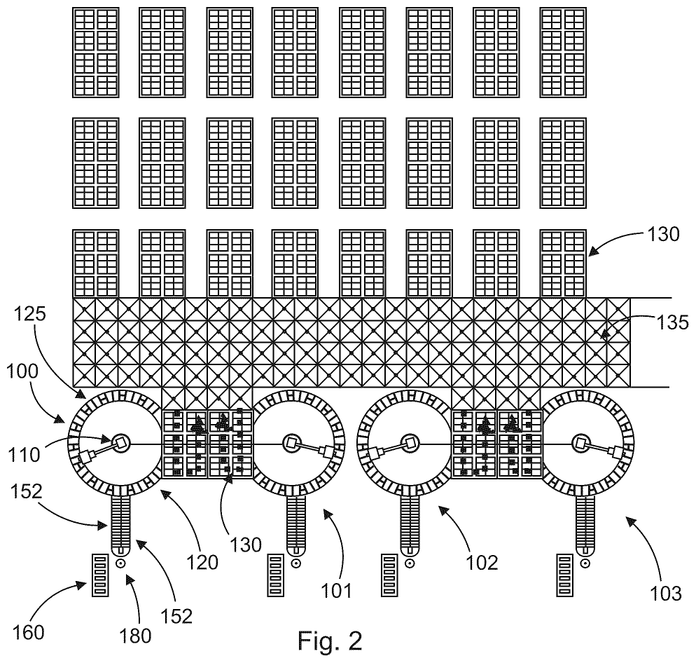

FIG. 2 sketches schematically an arrangement including a first automated storage and retrieval system 100 and a second automated storage and retrieval system 101. A further arrangement of two automated storage and retrieval systems are indicated by the reference 102 and 103. The first automated storage and retrieval system 100 can be configured as any one of the automated storage and retrieval systems 100 described above and the second automated storage and retrieval system 101 can be as well configured as described above.

The storage unit 120 of the first automated storage and retrieval system 100 is oriented in respect to a storage unit 120 of the second automated storage and retrieval system 101 in such a way, that a respective part of the periphery border of a respective center of the respective storage unit 120, wherein the part of the periphery border is configured for enabling access to the respective second plurality of cases by means of a respective mobile rack 130, are facing each other.

For this arrangement of storage and retrieval systems a plurality of mobile racks 130 can be stored outside of the arrangement. A plurality of autonomous mobile robots can be configured to provide a respective first mobile rack 130 to the respective automated storage and retrieval system 100, 101, 102, 103. Each of the respective automated storage and retrieval systems 100, 101, 102, 103 can include a picking station 160, and a U-type conveyor 152, wherein an operator 180 can pick items.

Using this arrangement enables a provision of at least one mobile rack 130 to the respective automated storage and retrieval system 100, 101, 102, 103 of the arrangement out of a U-formed queue of mobile racks 130, wherein the at least one mobile rack 130 can arrive at the part of the respective periphery border for access of the cases of the at least one mobile rack by the respective automated storage and retrieval system 100, 101, 102, 103. Advantageously, the U-formed queue of mobile racks 130, which is located close to the respective storage and retrieval system 100, 101, 102, 103, does not interfere with a floor 135 for fast moving of mobile racks 135 shown in FIG. 2.

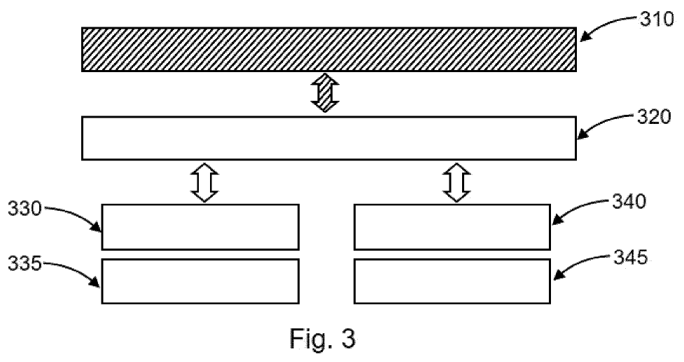

FIG. 3 schematically sketches a control system 300 for controlling storage and retrieval of cases by the storage and retrieval system 100. The control system 300 includes a customer warehouse management unit 310 to manage customer's warehouse by a customer themselves. A warehouse control unit 320, which is coupled to the customer warehouse management unit 310 is configured for receiving orders from the customer warehouse management system and for defining at least one order line for the received order and/or analyzing order fulfillment strategy with pre-designed algorithms. The order fulfillment strategy can mean, which order needs to be picked with a higher priority and/or an ABC analysis and/or a preparation for orders for a next day. A fleet management control unit 330, which is coupled to the warehouse control unit 320 is configured for controlling a movement of a plurality of automated guided vehicles 335 and/or of a plurality of autonomous mobile robots 335 according to the at least one order line. Additionally, a control system for a storage and retrieval machine 345 of the storage and retrieval system 100, which is coupled to the warehouse control system 320 is configured for controlling a provision of a case of a first and/or second and/or third plurality of cases according to the at least one order line.

In the context of the present disclosure, the automated storage and retrieval system can include a plurality of mobile racks, also referred to as goods to person system, to store cases, and the storage unit, which can be configured as an intermediate storage place for cases. A mobile rack can for instance be up to 3, 8 meter high, and can be configured to be suitable to store uniform cases.

Each mobile rack can be configured to be transported by means of an autonomic mobile robot, which can be included in the automated storage and retrieval system. The automated storage and retrieval system can also include a fleet management unit for managing a plurality of movements of the mobile racks by means of a plurality of autonomic mobile robots. Additionally, the automated storage and retrieval system can include a picking station and a replenishment station, which can be according to or similar to the classic goods to person mobile rack solutions in the market.

The storage and retrieval machine is configured for synergistically working together of the storage unit and the storage and retrieval machine. The storage and retrieval machine for instance can include a robot arm, which can be configured to pick cases as well from the mobile racks a from the storage unit.

Overall, the automated storage and retrieval system can provide a Goods-to-person system including an intermediate buffer, by means of the storage unit, and/or a picking station, by means of the storage and retrieval machine.

That means that the storage and retrieval machine can be configured to pick and retrieve cases from a mobile rack and to provide cases from a mobile rack or from the storage unit to a receiver, like an operator and/or a mobile robot.

The automated storage and retrieval system can be configured to operate independent of an operator by intermediate storage of cases within the storage unit, particularly according to an order line. The cases can be provided for access of the storage and retrieval machine by means of autonomous mobile robots. This can result in a higher system utilization and/or a lower quantity of needed autonomous mobile robots, to reduce the cost and to achieve a higher throughput.

The system can work effectively even without requiring an operator at a picking station at all time. The robot arm can start picking and/or accessing and storing cases from mobile rack to the buffer system during operation rest time to prepare for the orders being picked. During the manual picking process, this can reduce the mobile rack transportation quantity and increase the efficiency.

Using other words, by means of the automated storage and retrieval system an intermediate buffer, particularly the storage unit, can be provided for fast movers and/or orders can be prepared without an operator, for instance for a next day and/or cases can be relocated to the mobile rack.

In addition, the automated storage and retrieval system can be configured for order preparation by mobile rack inventory optimization, for instance, by relocating combined selling goods into one mobile rack.

Because a hitting rate is limited by a size of an order pool and a rack capacity, using the intermediate buffer, that means the storage unit, a large order pool can be provided to improve the hitting rate. An improved hitting rate can increase a system performance and a reduction of an overall cost.

Because 20% of a typical Stock Keeping Unit (SKU) represent A-goods, which can be fast movers covering 70-80% of an outbound of a goods to person system.

The automated storage and retrieval system can be configured to analyze, which type of goods are A-movers for buffering them by means of the storage unit. This can result in a reduction of 70%-80% transportation effort for moving mobile racks by means of autonomic mobile robots.

As an example, the storage unit can be configured to store up to 600 cases, which offers an increase of the capacity by a factor of 15 compared with a conventional put wall at a picking station. This expansion of an intermediate buffer capacity allows to increase the order pool, i.e. the amount of boxes that are accessible to the operator for order picking. Increasing the available order pool results in higher hitting rates for each mobile rack transportation. Consequently there are more cases available being buffered in the storage unit ready for the next step, which can be a manual picking.

According to an aspect, the automated storage and retrieval system is configured by a configuration of the storage unit and by a configuration of the storage and retrieval machine for enabling access to the first plurality of cases accommodated by the storage unit and to the second plurality of cases stored by means of the first mobile rack.

According to an aspect, the storage unit can be configured, by means of a plurality of shelfs, at a periphery border of a center of the storage unit to enable a circular access of the storage and retrieval machine of the stored cases.

According to an aspect, the storage and retrieval machine can be configured to access individual cases of the first and the second plurality of cases, by means of a retrieval tool adapted to engage a respective case.

According to an aspect, the storage and retrieval machine is configured to cooperatively store and retrieve cases to and from the storage unit for use as an intermediate storage buffer for the automated storage and retrieval system.

According to an aspect, the storage and retrieval machine comprises a serial robot arm. A serial robot arm can be described as a chain of links that are moved by joints, which are actuated by motors. An end-effector, also called a robot hand, and/or a tool adapter and/or a suite of grippers can be attached to the end of the chain. The serial robot arm can be configured to include that least six degrees of freedom to enable the robot hand to reach an arbitrary pose, i.e. a position and an orientation, in a three-dimensional space.

According to an aspect, the robot arm comprises six rotary joints to be configured for accessing the first plurality and the second plurality of cases and/or the third plurality of cases of the second mobile rack.

According to an aspect, the storage and retrieval machine is configured to operate in a center of the storage unit, wherein the center is defined in such a way, that the storage and retrieval machine can access all storage sites of the storage unit and/or the at least one first mobile rack and/or the at least one second mobile rack.

Alternatively, or additionally, the storage and retrieval machine can be located in a center of a periphery border of the storage unit.

According to an aspect, the storage and retrieval system is configured to accommodate the at least one mobile rack at a periphery border of the center of the storage unit for enabling access to the second plurality of cases by means of the storage and retrieval machine, wherein the second plurality of cases are stored by means of the first mobile rack.

According to an aspect, the automated storage and retrieval system is configured for enabling access to a third plurality of cases stored by means a second mobile rack and to the second plurality of cases stored by means the first mobile rack.

According to an aspect, the supply unit comprises a conveyor for providing the case by means of the storage and retrieval machine.

Additionally, or alternatively, the conveyer can include a two layer conveyor and/or a U-type conveyer for inbound and outbound of cases.

According to an aspect, the automated storage and retrieval system includes a picking station and/or a picking interface for picking items provided by at least one of the first plurality and/or second plurality and/or third-plurality of cases.

According to an aspect, the picking station and/or a picking interface can be configured such that the case can be placed in ergonomic height for an operator, which helps to reduce the overall solution cost and improve the efficiency.

According to an aspect, the automated storage and retrieval system further includes a plurality of automatic guided vehicles and/or a plurality of autonomous mobile robots, which are configured for moving the first mobile rack and/or second mobile rack to and/or from the automated storage and retrieval system.

According to an aspect, the automated storage and retrieval system further includes a plurality of mobile racks, including the first mobile rack and the second mobile rack, which are each configured to be moved by one of the plurality of automatic guided vehicle and/or by one of the plurality of autonomous mobile robot.

An arrangement of storage and retrieval systems is proposed including a first automated storage and retrieval system as described above and a second automated storage and retrieval system as described above, wherein a storage unit of the first automated storage and retrieval system is oriented in respect to a storage unit of the second automated storage and retrieval system in such a way, that a part of a respective periphery border of a respective center of a respective storage unit, for enabling access to a respective second plurality of cases provided by means of a respective mobile rack, are facing each other.

The part of a respective periphery border of a respective center of a respective storage unit can be an interruption in the structure of the storage unit, which is configured for enabling access for a respective mobile rack to give access to the respective plurality of cases stored within the respective mobile rack.

A method for providing at least one case to a supply unit of an automated storage and retrieval system is proposed, including the following steps. In one step the at least one case of a second plurality of cases is stored in a first mobile rack. In another step the first mobile rack is moving to a periphery of the storage and retrieval machine for enabling access to a second plurality of cases, by means of the storage and retrieval machine, wherein the second plurality of cases are stored by means of the first mobile rack. In another step the at least one case is stored within a storage unit of the storage and retrieval system by means of the storage and retrieval machine. In another step the at least one case is retrieved from the storage unit and provided to the supply unit by means of the storage and retrieval machine.

A control system, for controlling storage and retrieval of cases by the storage and retrieval system, is proposed, including a customer warehouse management unit to define an order, and including a warehouse control unit, which is coupled to the customer warehouse management unit and is configured for defining at least one order line for the order. In addition, the control system includes a fleet management control unit, which is coupled to the warehouse control unit, configured for controlling a movement of a plurality of automated guided vehicles and/or of a plurality of autonomous mobile robots according to the at least one order line. In addition, the control system includes a control unit for a storage and retrieval machine of the storage and retrieval system, which is coupled to the warehouse control system, configured for controlling a provision of a case of a first and/or second and/or third plurality of cases according to the at least one order line.

A use of the automated storage and retrieval system to provide at least one case of a second plurality of cases stored by means a first mobile rack to a supply unit of a storage and retrieval system is proposed, for picking of an item of the case. A use of the automated storage and retrieval system is proposed, for providing goods, which are stored in cases of a mobile rack storage system to an operator.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An automated storage and retrieval system, comprising:
a storage unit configured to accommodate a first plurality of cases;
a supply unit configured for providing at least one of the first and/or a second plurality of cases;
a storage and retrieval machine configured to access the plurality of cases of the storage unit and to provide at least one of the plurality of the cases to the supply unit;
wherein the storage and retrieval system is configured for enabling access to the second plurality of cases stored in a first mobile rack using the storage and retrieval machine.

2. The automated storage and retrieval system according to claim 1, further comprising a configuration of the storage unit and a configuration of the storage and retrieval machine for enabling access to the first plurality of cases accommodated by the storage unit and to the second plurality of cases stored using the first mobile rack.

3. The automated storage and retrieval system according to claim 1, wherein the storage and retrieval machine is configured to cooperatively store and retrieve cases to and from the storage unit for use as an intermediate storage buffer for the automated storage and retrieval system.

4. The automated storage and retrieval system according to claim 1, wherein the storage and retrieval machine comprises a serial robot arm.

5. The automated storage and retrieval system according to claim 4, wherein the robot arm comprises six rotary joints to be configured for accessing the first plurality and the second plurality of cases and/or the third plurality of cases of the second mobile rack.

6. The automated storage and retrieval system according to claim 1, wherein the storage and retrieval machine is configured to operate in a center of the storage unit, and wherein the center is defined such that the storage and retrieval machine can access all storage sites of the storage unit.

7. The automated storage and retrieval system according to claim 6, further comprising at least one mobile rack at a periphery border of the center of the storage unit for enabling access to the second plurality of cases by the storage and retrieval machine, wherein the second plurality of cases are stored by the first mobile rack.

8. The automated storage and retrieval system according to claim 1, further comprising a third plurality of cases stored by a second mobile rack, wherein the second plurality is stored by the first mobile rack.

9. The automated storage and retrieval system according to claim 1, wherein the supply unit comprises a conveyor.

10. The automated storage and retrieval system according to claim 1, further comprising a picking station for picking items.

11. The automated storage and retrieval system of claim 1, further comprising a plurality of automatic guided vehicles and/or a plurality of autonomous moving robots, which are configured for moving the first mobile rack and/or second mobile rack to and/or from the automated storage and retrieval system.

12. The automated storage and retrieval system according to claim 1, further comprising a plurality of mobile racks including the first mobile rack (130) and the second mobile rack, which are each configured to be moved by one of the plurality of automatic guided vehicle and/or by one of the plurality of autonomous moving robots.

13. An arrangement of storage and retrieval systems comprising:
a first automated storage and retrieval system;
a second automated storage and retrieval system;
wherein each of the first and second automated storage and retrieval system includes:
a storage unit configured to accommodate a first plurality of cases;
a supply unit configured for providing at least one of the first and/or a second plurality of cases;
a storage and retrieval machine configured to access the plurality of cases of the storage unit and to provide at least one of the plurality of the cases to the supply unit;
wherein the storage and retrieval system is configured for enabling access to the second plurality of cases stored in a first mobile rack using the storage and retrieval machine;
wherein the storage unit of the first automated storage and retrieval system is oriented in respect to the storage unit of the second automated storage and retrieval system such that a part of a respective periphery border of a respective center of the respective storage unit, for enabling access to a respective second plurality of cases provided by a respective mobile rack, are facing each other.

14. A control system for controlling storage and retrieval of cases by a storage and retrieval system, comprising:
a customer warehouse management unit to define an order;
a warehouse control unit, which is coupled to the customer warehouse management unit and is configured for defining at least one order line for the order;
a fleet management control unit, which is coupled to the warehouse control unit, is configured for controlling a movement of a plurality of automated guided vehicles and/or of a plurality of autonomous moving robot according to the at least one order line; and
a control unit for a storage and retrieval machine of the storage and retrieval system, which is coupled to the warehouse control system, is configured for controlling a provision of a case of a first plurality of cases and/or second plurality of cases and/or third plurality of cases according to the at least one order line.
